(19) United States
(12) Patent Application Publication
(10) Pub. No.: US 2022/0076349 A1
(43) Pub. Date: Mar. 10, 2022

(54) KAF Model of Electronic Fiscalization

(71) Applicants: Martha Karina Amezcua Luján, SR., Ciudad Guzmán (MX); Felipe Santoyo Telles, SR., Ciudad Guzmán (MX)

(72) Inventors: Martha Karina Amezcua Luján, SR., Ciudad Guzmán (MX); Felipe Santoyo Telles, SR., Ciudad Guzmán (MX)

(21) Appl. No.: 17/013,832

(22) Filed: Sep. 7, 2020

(51) Int. Cl. G06Q 40/00; G06Q 10/10

(52) U.S. Cl. CPC G06Q 40/10; G06Q 10/10

(57) ABSTRACT

The model of electronic fiscalization to predict, prevent, detect, correct and check the non-compliance fiscal obligations, innovates by implementing forensic audit tools and techniques that improve the fiscalization process in public institutions of fiscalization by tax administrations, without going to court to be used. The KAF model of electronic fiscalization innovates from the interaction of four elements: instruments, phases, approaches and effects, its functionality is explained by criteria the process starts with the implementation of the instrument that corresponds to the forensic tools or techniques chosen to be applied in the phases of the process, the approaches are presented according to the phases and effects align with the approaches and generate actions, innovating also one new approach and effect: the predictive. It is a promising tool for the field of risk engineering in electronic fiscalization by the increased use of electronic media to compliance fiscal obligations and its checking.

### CROSS REFERENCE TO RELATED APPLICATIONS

Not applicable

### STATEMENT REGARDING FEDERALLY SPONSORED RESEARCH AND DEVELOPMENT

Not applicable

### THE LATIN NAME OF THE GENUS AND SPECIES OF THE PLANT CLAIMED

Not applicable

### VARIETY DENOMINATION

Not Applicable

### BACKGROUND OF THE INVENTION

For the tax administrations, the evaluation and detection of tax non-compliance observed to taxpayers by the administrative authority is a relevant aspect because it is part of the variables that make up some indicators that measure the effectiveness of these public institutions, therefore, reducing and eliminating failures in their system of fiscalization and improve their process of fiscalization it is essential. Fiscalization involves verification activities, which according to the Organization for Economic Cooperation and Development (OECD) are “usually developed by tax administration institutions to verify taxpayers have correctly reported their tax obligations” (2009, p. 110)¹. In this sense, Buchahin² (2015, p. 50) points out that fiscalization involves “inspecting individual subjects or legal entities, entities and/or their activities to check if they pay taxes or examine, control or criticize the actions of others” a term that incorporates various elements or activities that can be developed through the proposed model. The invention arises from the need to propose solutions to the problem of inefficiency in institutions of fiscalization, considering the reduced universe of audited taxpayers, then, reduce inefficiencies in the process of fiscalization is possible through scientific disciplines such as forensic auditing which Estupiñan³ identifies as a special investigation in which situations of fraud or abuse of position of trust are resolved and the experience of the public accountant is brought to the judicial strata in situations of fraud (2006, 431 and 433) and according to Castro and Cano⁴ (2003, 1) is used for “discover, divulge, and attest to frauds and crimes in the development of public and private functions. Whose tools and techniques are currently used to persuade judge fraud, economic crimes, and acts of corruption. In this sense, the KAF model of electronic fiscalization improves the process of fiscalization and brings an innovative aspect to the function of fiscalization that using traditional auditing techniques and procedures limiting it to the review and verification, on the other hand, with the use of specialized technologies such as tools or techniques of forensic auditing, an investigative approach is brought to the acts of fiscalization for the determination of a tax credit, being able to be applied at an administrative authority level without having to go to court to be used to use of forensic sciences and techniques, since currently these are applied when a tax crime exists. ¹ OECD. (2008). The Tax Administration in OECD countries and certain non-member countries: Serie “Comparative Information” Series (2008). [La Administración Tributaria en los paises de la OCDE y en determinados paises no miembros: Serie “Información Comparada” (2008]). http://www.oecd.org/ctp/administration/46668703.pdf² Buchahin, A. M. D. (2015). Forensic Audit Crimes against the Public Administration [Auditoria Forense Delitos contra la Administración P\dot{u}blica]. México: Bosch³ Estupiñán, G. R. (2006). Internal Control and Frauds based on transactional cycles. Report Analysis COSO I, II y III. Based on the transactional cycles [Control Interno y Fraudes con base en los ciclos transaccionales. Análisis de Informe COSO I, II y III. Con base en los ciclos transaccionales]. Bogotá: Ecoe Ediciones⁴ Castro V., R. M. y Cano C., M. A. (2003). Forensic Audit. [Auditoria Forense]. Legis International Journal of Accounting and Auditing. 13. 155-185. ISSN: 1692-2013. http://legal.legis.com.co

The present invention constitutes a model that includes elements and criteria capable of being adapted to processes of fiscalization in institutions of fiscalization of the systems of fiscalization in the tax administrations established in its regulations and to the audit processes established in the auditing standards. There is no known model of electronic fiscalization, prior or otherwise, that is important for the present invention.

### SUMMARY OF THE INVENTION

The invention takes the form of a model of electronic fiscalization that integrates the application of forensic tools and techniques for the improvement of the process of fiscalization of public institutions of fiscalization in tax administrations to predict, prevent, detect, correct and prove the failure to comply with tax obligations at the level of administrative authority without being necessary to reach courts to be used. The KAF model of electronic fiscalization allows close interaction between traditional audit, tax verification or control, and forensic audit, going from the review or verification characteristic of a traditional audit system to the use of specialized tools and techniques that provide an investigative approach aimed at increasing the effectiveness of the audit systems in tax administrations because of the problems facing the administration to increase the effectiveness of the audit activities.

The KAF model of electronic fiscalization additionally innovates from the interaction of the elements that integrate it such as instruments, approaches, phases, and effects, whose interaction and functionality are based on criteria. The instruments imply the use of tools or forensic techniques of auditing without being necessary to reach courts to be used, innovative features in the model since from the theoretical aspect they are used when a fiscal crime is presented. The three proposed phases are aligned both with the process of fiscalization of a tax audit and with the phases included in the audit standards, the five proposed approaches are generated according to the instruments selected to execute the activities and audit procedures planned in each of the phases, being possible the presence of one or several approaches in one phase or along with the three phases in a simultaneous and repeatable way, finally, the effects are derived from the approaches and are generators of actions, which materialize such effects.

### BRIEF DESCRIPTION OF THE DRAWING

FIG. 1. It schematically illustrates an electronic audit model that incorporates forensic audit tools and techniques to predict, prevent, detect, and prove non-compliance with tax obligations.

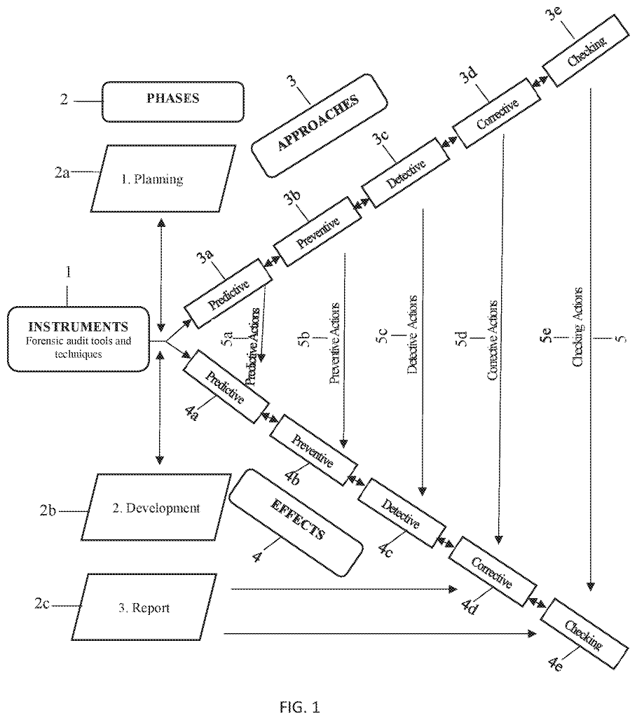

1 Instruments. They are the use of forensic tools and techniques during the planning and development phases.

2 Phases. The three phases of the process of fiscalization are. 2a. Planning. In this phase, premises are established on the behavior of the taxpayer concerning the correct fulfillment of tax obligations. 2b. Development. In this phase, the audit procedures are executed with the use of forensic tools and techniques. 2c Report. In this phase, the results of the tax audit or audit report are issued.

3 Approaches. The approaches that are generated as a result of the application of the forensic audit tools and techniques and audit procedures. 3a Predictive. An approach that is presented as a result of audit procedures with the use of forensic audit tools or techniques and it is conjectured or issued premises non-compliance tax obligations. 3b Preventive. This approach is presented as a result of audit procedures with the use of forensic audit tools or techniques and prevents inconsistencies, irregularities, or omissions that generate non-compliance tax obligations. 3c Detective. Approach that occurs as a result of audit procedures with the use of forensic audit tools or techniques and irregularities or omissions are detected that generate non-compliance tax obligations. 3d Corrective. Approach encourage taxpayer self-correction for non-compliance tax obligations. 3e Checking. This approach implies the collection or obtaining of documentary or digital evidence that supports the correct fulfillment of fiscal obligations, as well as, their non-compliance.

4 Effects. The effects arise from the approaches and are generators of actions in the same sense. 4a Predictive. Effect arises from the predictive approach and generates predictive actions executed by the institution of fiscalization to establish premises on the non-compliance of fiscal obligations. 4b Preventive. This effect arises from the preventive approach and generates preventive actions executed by the institution of fiscalization to prevent non-compliance with fiscal obligations. 4c Detective. This effect arises from the detective approach, generating detective actions executed by the institution of fiscalization and as a result inconsistencies, irregularities, or omissions are detected that imply the non-compliance of fiscal obligations. 4d Corrective. This effect arises from the corrective approach and encourages taxpayer self-correction through corrective actions executed by the taxpayer to correct inconsistencies, irregularities, or omissions that generate the failure to comply with tax obligations detected and verified by the institution of fiscalization. 4e Checking. This effect arises from the checking approach and generates actions that are executed by the institution of fiscalization to check with physical or digital documentation the taxpayer inconsistencies, irregularities, or omissions.

5a Predictive Actions. It materializes the predictive effect with actions through which premises are established about the non-compliance of fiscal obligations. 5b Preventive Actions. It materializes the preventive effect with actions through which the non-compliance of fiscal obligations is prevented. 5c Detective Actions. It materializes the detective effect with actions through which inconsistencies, irregularities, or omissions are detected. 5d Corrective Actions. It materializes the corrective effect with actions through which the taxpayer is encouraged to correct inconsistencies, irregularities, or omissions. 5e Checking Actions. It materializes the checking effect with actions through which inconsistencies, irregularities, or omissions of the taxpayer are checking with physical or digital documentation.

### DESCRIPTION OF THE INVENTION

the KAF model of Electronic Fiscalization innovates with the use of forensic audit tools and techniques to predict, prevent, detect, correct, and checking the non-compliance of fiscal obligations, also, it can be integrated to the process of fiscalization to improve it, from the planning of the fiscalization act, at the beginning of the checking faculties, its execution and until the conclusion of a fiscal audit, it proposes the interaction of four elements: instruments, phases, approaches, and effects.

The KAF model of Electronic Fiscalization is also based on the following criteria: the instruments imply the use of tools or forensic audit techniques without being necessary to reach courts to be used, an innovative feature in the model since from the theoretical aspect it is not considered, currently, the forensic audit is applied only when a tax crime or finance is configured and it is reached to jurisdictional headquarters, the three phases proposed in the model are: planning, development, and reporting are aligned to the audit process of a tax audit that comprises the phases of planning and programming of acts of fiscalization, practice or execution of audit acts in the exercise of the checking faculties of administrative authority and its conclusion, as with two phases included in the audit standards planning, execution and completion of the audit process.

On the other hand, the five proposed approaches are generated according to the instruments selected to execute the activities and audit procedures planned in each of the phases, is possible the presence of one or several approaches in one phase or along with the three phases simultaneously and repeatable. In the KAF Model of Electronic Fiscalization, besides prevention and detection, three additional approaches are incorporated: predictive, corrective, and verification, concerning the predictive and preventive approaches, it is specified that they arise before the beginning of checking faculties, on the contrary, the detective, corrective and verification approaches, are presented before and during the exercise of verification faculties, likewise, an innovative element in the model is the predictive approach, not considered by the forensic or traditional audit. Finally, there are the effects that are derived and aligned to the approaches, are generators of actions that materialize these effects, replicating them through three phases of the process of fiscalization.

The instruments are the tools or forensic audit techniques selected to be applied in each of the phases of the KAF Model of Electronic Fiscalization, they provide greater depth to the audit procedures and strength to the evidence obtained because they are specialized tools or techniques that in addition to expediting the review and verification of proper compliance with fiscal obligations gives the tax audit an investigative cut, are used in the planning and development phases.

There are three phases proposed in the model, planning, development, and reporting:

Phase 1. Planning. The premises on the behavior of the taxpayer concerning the correct compliance of fiscal obligations are established to determine its level of risk based on the collection of information and tax documentation of the taxpayer collected by the institution of fiscalization the beginning of checking faculties, so there is a possibility that the premises raised in the planning are wrong if this situation occurs it is solved in the development phase. The planning implies aspects such as the selection of the taxpayer, audit background, scope, review period that may correspond to a fiscal year that in Mexico is twelve months, reviews can also be done for periods less than a year, the personnel is assigned, the procedures and activities to be executed are planned taking into account the premises raised about possible inconsistencies, irregularities or omissions until the moment only are premises, defining the taxes, items, and aspects that will be verified. In this phase, the development and reporting phases are also configured and the presence of the predictive, preventive, corrective, and checking approaches and effects is feasible. When using forensic tools or techniques, it is recommended that specialist personnel in this area participate, who will collaborate with the person responsible for the audit or the training of tax auditors in their use.

Phase 2. Development. The audit procedures are executed with the use of forensic tools and techniques. The development phase offers the opportunity to confirm or dismiss the premises raised in the planning phase in which the taxpayer was classified at a risk level, as well as, to detect new irregularities or tax omissions. Four steps are suggested in this phase: 1. analyze data or information stored in electronic devices and media in which the transactions or operations of the taxpayer are recorded, such as accounting records and tax information 2. verify the result of the analysis the irregularities or omissions that imply the non-compliance of fiscal obligations are detected, as well as, those of operations that do not derive in observations. 3. identify and quantify irregularities or omissions that imply the non-compliance of fiscal obligations to know their amount, likewise, operations that do not result in observations are quantified 4. collect and keep the physical or digital documentary evidence that supports the irregularities or omissions detected and that gave rise to the non-compliance of fiscal obligations, as well as, the evidence that supports the auditing procedures applied, which, could consist of invoices issued by the taxpayer, bank statements or information and documentation obtained from related third parties The evidence is collected and safeguarded by the institution of fiscalization and must be conclusive evidence for the taxpayer and irrefutable for a judge. In this phase, planning is also made, the premises raised are analyzed and confronted with the information provided by the taxpayer, and new proposals for audit procedures and analysis may arise, a partial report is made, since, by disclosing the results of the audit to the taxpayer before the issuance of the resolution determining the tax credit, the taxpayer may self-correct all or partially its tax situation, in this phase, it is feasible the presence of the preventive, detective, corrective and checking approaches because the beginning of checking faculties was initiated to the taxpayer.

Phase 3. Report. The final results of the tax audit or audit act are issued, presenting the approaches and corrective effects, as well as, of verification, since the irregularities or omissions generating some non-compliance of fiscal obligations by the taxpayer were already identified, the amount of the omitted contributions, accessories, sanctions are known and the evidence of physical or digital documentary audit is available, which proves them reliably and categorically, it is also known if the taxpayer incurred in a tax offense. The above is disclosed to the taxpayer, the approach and corrective effect are materialized if the taxpayer self-corrects its tax situation during the development of the tax audit or act of audit by making a partial or total payment of contributions omitted and its accessories. If the taxpayer corrects itself partially or not at all, a resolution determining the tax credit will be issued with the possibility of going to court.

Additionally, the KAF Model of Electronic Fiscalization consists of five approaches: predictive, preventive, detective, corrective, and checking that are presented simultaneously or alternately in the three phases, after selection and implementation of the instrument or tools and forensic techniques, it should be noted that the same tool or forensic technique usually provides any of the proposed approaches, this will depend on the phase in which they are applied and the existence of inconsistencies, irregularities or tax omissions.

Predictive approach. It is presented as a result of audit procedures with the use of forensic audit tools or techniques and it is conjectured or issued premises about the non-compliance of fiscal obligations from indications derived from tax information obtained by the institution of fiscalization which infers the presence of inconsistencies, irregularities or omissions that generate the non-compliance of fiscal obligations during the planning phase, before the beginning of checking faculties.

Preventive Approach. It is presented as a result of audit procedures with the use of forensic audit tools or techniques and prevents inconsistencies, irregularities, or omissions that generate non-compliance with fiscal obligations so that they are corrected without the beginning of checking faculties during the planning phase. In case of proven tax non-compliance during the execution of the audit activities in the development phase, the preventive element is granted by the capacity of the auditor to prevent that the detected inconsistencies, irregularities, or tax omissions are replicated in periods prior or after the review, having the taxpayer the option to self-correct its tax situation without the before the beginning of checking faculties.

Detective Approach. Occurs as a result of audit procedures with the use of forensic audit tools or techniques and irregularities or omissions are detected that generate non-compliance with fiscal obligations, it is par excellence the ideal instrument to discourage actions that cause non-compliance with fiscal obligations, approach closely related to the checking approach, once the tax non-compliance has been detected, the tax auditor must have the documentary or digital audit evidence to support it, determine the differences and therefore, the total amount of the omission due to the non-compliance.

It is presented during the execution of the act of fiscalization in the development phase and the assumptions raised during the planning phase are verified or dismissed, before the execution of an act of fiscalization, while the beginning of checking faculties happens in the development phase, it is the substantial approach of the tools or forensic audit techniques since all the tax and accounting information delivered by the taxpayer will be available, that is, irregularities are identified that result in the non-compliance of fiscal obligations.

The detection approach discourages actions tending to incur in tax non-compliance to the extent that the forensic audit tools or techniques increase the detection of tax inconsistencies, irregularities, or omissions, also increasing the efficiency of the audit procedures and the audit process, at the same time, it creates awareness in the taxpayer of the risk incurred in a tax non-compliance, inhibiting actions that lead him to commit them.

Corrective approach. Characterized by allowing the restitution of the non-compliance of fiscal obligations in any of the three phases proposed in the model when the taxpayer self-corrects its fiscal situation by correctly complying with its fiscal obligations and making the total payment of contributions and accessories.

Checking Approach. It implies the collection or obtaining of the documentary or digital evidence that supports both the correct compliance with fiscal obligations and the non-compliance with these obligations. The verification approach is influenced by the rest of the approaches proposed in the model, but without a doubt, mostly the detective one, it is presented in any of the three phases, and it undoubtedly plays a fundamental role in the development phase since during the execution of the audit act the audit evidence is collected and, if necessary, it is transferred to the taxpayer so that he can solve or clarify any request for information made by the institution of fiscalization. In the report phase, the approach is appreciated by disclosing the inconsistencies, irregularities, or omissions to the taxpayer-supported by the respective documentary or digital evidence, being also relevant for the determination of the tax credit due to the possibility of serving as evidence in a court, hence the importance of making a correct and conclusive verification.

In the KAF Model of Electronic Fiscalization, the above-mentioned approaches also produce five effects: predictive, preventive, detective, corrective, and checking, which are generated by actions in the same sense, being the actions a means for the materialization of the effects, they are implicit in them, therefore, they are not considered as another element of the model.

Predictive effect. It is provoked from the predictive approach and generates predictive actions executed by the inspection body to establish premises about the non-compliance of fiscal obligations by the taxpayer during the planning phase, before the beginning of checking faculties, the expected results are the resolution of the inconsistencies, irregularities or tax omissions and the total self-correction of the taxpayer.

Preventive Effect. It is caused by the preventive approach and generates preventive actions executed by the institution of fiscalization to prevent the taxpayer from failing to comply with fiscal obligations before the beginning of checking faculties, in the planning phase, in the execution of the act of fiscalization, and before the issuance of the tax credit resolution during the development phase, as well as, to prevent the risk incurred by the taxpayer from not self-correcting its tax situation in periods other than the one reviewed or for which it received an invitation to correct its tax situation to anticipate its spontaneous self-correction, without the existence of checking faculties

Detective Effect. It is caused by the detective approach, it generates detective actions executed by the institution of fiscalization and as a result inconsistencies, irregularities or omissions are detected that imply the non-compliance of fiscal obligations by the taxpayer, it occurs during the execution of the inspection act in the development phase.

Corrective Effect. It is provoked from the corrective approach and generates corrective actions executed by the inspection of fiscalization to encourage the taxpayer to correct inconsistencies, irregularities, or omissions that generate the non-compliance of fiscal obligations detected and verified before the beginning of checking faculties, during the execution of the inspection act or before the issuance of the tax credit resolution and as a result, the taxpayer self-corrects its tax situation, therefore, it appears in any of the three phases.

Checking Effect. It is caused from the checking approach and generates actions that are executed by the institution of fiscalization to check with physical or digital documentation obtained by such institution of fiscalization, provided by the taxpayer or related third parties, the inconsistencies, irregularities, or omissions that generate the non-compliance of fiscal obligations detected, audit evidence that must be reliable for the taxpayer and irrefutable evidence to be presented before a judge, is presented in any of the three phases.

1. A model of electronic fiscalization to predict, prevent, detect, correct, and check the non-compliance fiscal obligations. The model is integrated into four elements: instruments, phases, approaches and effects, the interaction and functionality explained by criteria, and forensic audit tools and techniques that can be applied without having to go to court to be used. The model can improve the process of fiscalization in public institutions and a private sector audit process for its adaptability, flexibility, interaction, and operation of its elements, the KAF model of electronic fiscalization comprises the following elements and criteria:
a) Instruments. In the model, are the selected forensic audit tools or techniques, provide a research approach by the use of a scientific discipline, improving the efficiency of the fiscalization system from planning and during the execution of fiscalization audit or tax audit for the determination of tax credits currently apply only when a tax offense is configured and reach the court of jurisdiction, the model proposes it's use without having to go to court, this being an innovative feature of the KAF model of electronic fiscalization and are applied in the planning and development phases.
b) Phases. There are three phases of the model: Planning, development, and report are the stages into which the process of fiscalization is divided and are aligned to the process of fiscalization in public institutions of fiscalization and audit process according to auditing standards.
c) Approaches. There are five approaches of the model: predictive (is presented at the planning phase), preventive (is presented at the planning phase), detective (is presented at the development phase), corrective (is presented at the three phases: planning, development, and report) and checking (is presented at the three phases: planning, development, and report), are generated as a result of the application of the forensic audit tools and techniques and audit procedures to predict, prevent, detecting, correcting and checking the non-compliance fiscal obligations.
d) Effects: There are five effects of the model: predictive (is presented at the planning phase), preventive (is presented at the planning phase), detective (is presented at the development phase), corrective (is presented at the three phases: planning, development, and report) and checking (is presented at the three phases: planning, development, and report), are generated as a result of the application of the (forensic audit tools and techniques), are detached and aligned with the approaches, are generators of actions in the same direction, which materialize these effects.
